(19) United States
(12) Patent Application Publication
(10) Pub. No.: US 2009/0138397 A1
(43) Pub. Date: May 28, 2009

(54) Credit card payment system and method

(76) Inventor: Bansi Lal Sharma, Morristown, NJ (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 11/986,614

(22) Filed: Nov. 23, 2007

(51) Int. Cl. G06Q 20/00; G06Q 30/00

(52) U.S. Cl. 705/40; 235/381; 705/41; 705/44

(57) ABSTRACT

A credit card payment system and method includes a zero-LOC card having a unique identification number and a zero line of credit issued to an individual or a small business. The zero-LOC card is appointed to be funded by at least one transfer from a funding card account to provide a credit balance on the zero-LOC card. A sub-product code is integrated within the card system to provide restrictions or expansions to usage and function of the zero-LOC card. Storage, computing and communication means are provided. Existing cardholders allocate their assigned lines of credits in creative ways to address their individual needs. The credit card payment system allows cardholders to allocate their unused credit lines at their own expense and to the mutual benefit of consumers, small businesses, merchants and credit card issuing companies, thereby facilitating more frictionless trade and growing the economy.

### BACKGROUND OF THE INVENTION

1. Field of the Invention

The present invention relates to a credit card payment system and method; and more particularly to a credit card payment system and method including a credit card having a unique identification number and a zero line of credit (except for an optional overdraft limit), henceforth referred to as a zero-LOC card or a zLOC card, issued to an individual or a small business, that is funded by a money transfer from a funding card account's available line of credit.

2. Description of the Prior Art

Fewer and fewer individuals carry any significant amount of cash upon their person. In lieu of carrying cash, credit cards/debit cards have become a mainstay for everyday payments. Credit cards provide tremendous convenience over cash and checks but are not available to a large segment of the population. This is the case even when there are a large number of credit-worthy cardholders who are willing to extend credit to these individuals on a transactional basis but are not willing to become guarantors to get regular credit cards issued to these individuals. Plastic payment cards currently can be grouped into three predominant categories: (i) charge/credit cards; (ii) debit cards; and (iii) prepaid cards. However, none of these card types offers a versatile card system adapted for specifically allocating a part of the line of credit from an existing credit card to another card, in essence allowing current credit card holders to responsibly allocate a part of their available line of credit to others, or to another of their own cards, while continuing to assume full financial responsibility for the transaction just as they do for any other payment made using their current credit card. Moreover, none of these card types provide a plastic payment instrument especially adaptable for multiple end uses capable of being tailored for specific uses, such as: (i) a teen credit card with specific limits that can later on be graduated to a regular credit card; (ii) a budget credit card to compartmentalize one's spending; (iii) an enhanced privacy protection credit card; (iv) a plurality of cards with customized spending limits that are all funded from a centralized credit card for distribution within a family or small business; (v) a published credit card that can be used to receive payments for goods and services; or (vi) a credit card used to give a personal loan or gift to a trusted friend, associate or a family member.

Various prepaid or gift card systems have been provided, wherein a person generally buys a card with an amount associated with the card for use as a prepaid card (such as a phone/gas card) or as a gift card. For example: U.S. Pat. No. 6,473,500 to Risafi et al. discloses a system for using a prepaid card permitting a card user to purchase a card, issued by an issuer such as a bank, through an agent at a retail establishment via a terminal and use the card to purchase goods and services, and reload the card for future use; U.S. Pat. No. 6,615,189 to Phillips et al. discloses a purchase card that is purchased by a purchaser for a designated recipient, wherein the purchase card may also be converted to a credit card; U.S. Patent Application Publication No. 20030053609 to Risafi et al. discloses a system and method for transferring money by use of a prepaid card account wherein two cards are issued to the user accountholder, one of which is provided to another user, and either user may add value to the prepaid account so that the other user may use the card and that value in a financial transaction; U.S. Patent Application Publication No. 20040064412 to Phillips et al. discloses a method of issuing a purchase card including the steps of presenting a purchaser with the opportunity to buy the purchase card, determining whether the purchaser has sufficient funds, creating a purchase card account, and issuing the purchase card, wherein the purchase card may be issued in connection with another credit card, for example as a rebate for purchases on the credit card, and the purchase card may be converted to a credit card; U.S. Patent Application Publication No. 20040249752 to Prato et al. discloses a method enabling a prepaid, open-ended stored-value charity card to be used as a fundraising vehicle providing dollar-based monetary funding to pre-selected charities; U.S. Patent Application Publication No. 20020143703 to Razvan et al. discloses a cash card which is freely transferable, redeemable and usable and which a user can purchase with a set amount of credit thereon and add to the balance as it is used; U.S. Patent Application Publication No. 20030195842 to Reece discloses a method for making electronic transactions providing a limited-use credit card for use over a network such as the Internet and it has a limited life span and/or a limited spending limit corresponding to the amount of the stored value transaction optionally less a transaction fee; and Foreign Publication JP 2001/222665 to Awano discloses a card settlement system using a credit card.

Gift card type methods and systems generally similar to pre-paid cards have been provided. For example: U.S. Patent Application Publication No. 20070187487 to Wilen discloses a method of distributing and activating gift cards by attaching a non-activated gift card to an article and selling the article to a consumer so that the consumer activates the gift card by allocating a dollar valve to the gift card and then sends the gift card to a specific person as a gift; U.S. Pat. No. 5,984,180 to Albrecht discloses a method and system for providing purchasable value for gifts and other uses in the form of a credit instrument wherein purchaser of a gift credit instrument authorizes a credit institution with which the purchaser holds a credit account to create a limited-value, non-renewable secondary account linked exclusively to the purchaser's credit account, wherein the gift credit instrument may be used in the same manner as the purchaser's credit instrument but it expires after a certain period of time or after the initial value of the secondary account is spent; U.S. Pat. No. 7,128,261 to Henderson et al. discloses a method and apparatus for generating and dispensing gift cards for an associated merchant, wherein a customer enters a value for the gift card through a customer input pad, and pays for the card by swiping a credit card through a credit card reader; and U.S. Patent Application Publication No. 20020026418 to Koppel et al. discloses a method for providing a pre-paid anonymous electronic debit card compatible with an existing network of credit cards so that upon pre-payment by a customer, the issuer issues to the customer a pre-paid electronic debit card, bearing the name of the issuer, for accessing one of the sub-accounts; the customer can receive the card for personal use or send it to a third party, either as a gift or as payment for a purchase.

Devices, including microprocessors, semiconductor chips, or cards having multiple magnetic strips, for storing information via a plurality of cards on one card/device have also been provided. For example: U.S. Pat. No. 5,884,271 to Pitroda discloses a universal electronic transaction card (“UET card”) device with microprocessor capable of serving as a number of different credit cards, bank cards, identification cards, employee cards, medical and health care management cards and the like; U.S. Pat. No. 6,402,039 to Freeman et al. discloses a chip card including a flexible body; at least one semiconductor chip supported within the flexible body and comprising a memory for storing the information; and U.S. Pat. No. 6,631,849 to Blossom discloses a selectable, multi-purpose card comprising a plurality of features stored in memory means operatively mounted on the card and selection means for allowing a user to select a feature. In one embodiment the card includes a plurality of magnetic strips to allow swiping each magnetic strip separately.

Dual credit cards and non-credit card devices have been provided wherein a credit account is created along with transactional or debit card features. For example: U.S. Pat. No. 7,263,507 to Brake, Jr. et al. discloses a Customer Activated Multi-Value (CAM) card provides a customer with a primary use as a transaction card which can be further activated to have a secondary use as a credit card; and U.S. Patent Application Publication No. 20050077350 to Courtion et al. discloses a dual card, which facilitates payment for goods or services from either a credit account or a stored value account.

Additionally, various sponsor cards and/card funding vehicles have been provided, but these devices fail to provide a general purpose credit card having a zero line of credit (except for an optional overdraft limit) that is substantially funded by way of existing lines of credit from other credit cards with no limitations on how many times or how often the said card is funded from other credit cards. For example: U.S. Pat. No. 7,165,049 to Slater discloses a method and system for issuing a sponsor funded stored value card wherein a sponsor company funds an account associated with the stored value card and the card is issued to a cardholder, who can withdraw funds from the account, but cannot deposit additional funds in the account; Visa Buxx found at http://usa.visa.com/personal/cards/prepaid/buxx_faq.html?it=12|/personal/cards/prepaid/visa_buxx.html|FAQ#anchor_{—}3 discloses a prepaid, reloadable Visa card created especially for teens wherein parents enroll their teen in the program and monitor their teen's spending. Parents can set the spending limits by the prepaid amount loaded on the card. A Visa Buxx card cannot be upgraded to a regular credit card. U.S. Pat. No. 6,267,292 to Walker et al. discloses a financial tender transfer system that allows a transferor to transfer credit or make payments to a transferee by debiting the credit card of the transferor and crediting the credit card of the transferee so that the transferee has immediate access to the transferred money and ensures the transferor's credit card is valid, wherein any amount of value up to the full credit line of the transferor can be transferred to the transferee.

None of the references disclose a credit card system adapted for specifically allocating lines of credit from existing credit cards to a credit card that is issued without need for a credit check. Moreover, none of these card systems provide a plastic payment instrument especially adaptable for multiple end uses capable of being tailored for specific uses, such as: (i) a teen credit card with specific limits that can later on be graduated to a regular credit card; (ii) a budget credit card to compartmentalize one's spending; (iii) an enhanced privacy protection credit card; (iv) a plurality of cards with customized spending limits that are all funded from a centralized credit card for distribution within a family or small business; (v) a published credit card that can be used to receive payments for goods and services; or (vi) a credit card used to give a personal loan or gift to a trusted friend, associate or a family member.

Notwithstanding the efforts of prior art workers to construct various credit and prepaid cards, there remains a need in the art for a credit card payment system that includes a credit card having a unique identification number and a zero line of credit (except for an optional overdraft limit) issued to an individual or a small business that is funded by at least one line of credit transfer from a funding card account to provide a credit balance on the zero-LOC credit card. In addition, there exists a need for a credit card payment system that includes a zero-LOC credit card having sub-product codes associated with additional restrictions or expansions to yield varying credit card vehicles, including, but not limited to, variations such as: (i) a teen credit card with specific limits that can later on be graduated to a regular credit card; (ii) a budget credit card to compartmentalize one's spending; (iii) an enhanced privacy protection credit card; (iv) a plurality of cards with customized spending limits that are all funded from a centralized credit card for distribution within a family or small business; (v) a published credit card that can be used to receive payments for goods and services; or (vi) a credit card used to give a personal loan or gift to a trusted friend, associate or a family member.

### SUMMARY OF THE INVENTION

The present invention provides a credit card payment system and method for payment goods or services that includes a credit card having a unique identification number and a zero line of credit (except for an optional overdraft limit), henceforth referred to as a zero-LOC card or a zLOC card, issued to an individual or a small business, that is funded by a money transfer from a funding card account's available line of credit to provide a credit balance on the zero-LOC card. The credit card payment system further includes sub-product codes associated with additional restrictions or expansions to the zero-LOC card to yield varying credit card vehicles, including, but not limited to, variations such as: (i) a teen credit card with specific limits that can later on be graduated to a regular credit card; (ii) a budget credit card to compartmentalize one's spending; (iii) an enhanced privacy protection credit card; (iv) a plurality of cards with customized spending limits that are all funded from a centralized credit card for distribution within a family or small business; (v) a published credit card that can be used to receive payments for goods and services; or (vi) a credit card used to give a personal loan or gift to a trusted friend, associate or a family member.

Storage means are provided for storing the identification number and the sub-product code for the zero-LOC card. Computing means are provided for calculating the credit balance remaining on the zero-LOC card and for approving or declining a payment using the zero-LOC card. The credit card payment system further includes communication means for transmitting and receiving between the computing means the transaction information including the zero-LOC card identification number, or a proxy, and a payment transaction amount.

A method for providing a credit card for payment goods or services is provided. The method comprises the steps of: generating a zero-LOC card having a unique identification number and a zero line of credit (except for an optional overdraft limit); issuing the zero-LOC card to an individual or a small business; funding the zero-LOC card by at least one transfer from a funding card account to provide a credit balance on the zero-LOC card; creating a sub-product code being associated with additional restrictions or expansions to the zero-LOC card; storing the identification number and the sub-product code for the zero-LOC card on storage means; calculating the credit balance remaining and for approving or declining a payment made using the zero-LOC card; and transmitting and receiving between the computing means the transaction information including the zero-LOC card identification number, or a proxy, and a payment transaction amount.

### BRIEF DESCRIPTION OF THE DRAWINGS

The invention will be more fully understood and further advantages will become apparent when reference is made to the following detailed description of the preferred embodiments of the invention and the accompanying drawings, in which:

FIG. 1 illustrates a zero-LOC card of the credit card payment system and method;

FIG. 2 shows a schematic diagram of an embodiment of the credit card payment system and method wherein the zero-LOC card is being funded by a transfer from a funding credit card having a line of credit; and

FIG. 3 is a flow chart showing an embodiment of the credit card payment system wherein enhanced supplementary cards are provided via a plurality of zero-LOC cards issued for distribution within a family.

### DETAILED DESCRIPTION OF THE INVENTION

The present invention provides a credit card payment system and method for payment goods or services that includes a credit card having a unique identification number and a zero line of credit (except for an optional overdraft limit), henceforth referred to as a zero-LOC card or a zLOC card, issued to an individual or a small business, that is funded by a money transfer from a funding card account's available line of credit to provide a credit balance on the zero-LOC card. The credit card payment system further includes sub-product codes associated with additional restrictions or expansions to the zero-LOC card to yield varying credit card vehicles, including, but not limited to, variations such as: (i) a teen credit card with specific limits that can later on be graduated to a regular credit card; (ii) a budget credit card to compartmentalize one's spending; (iii) an enhanced privacy protection credit card; (iv) a plurality of cards with customized spending limits that are all funded from a centralized credit card for distribution within a family or small business; (v) a published credit card that can be used to receive payments for goods and services; or (vi) a credit card used to give a personal loan or gift to a trusted friend, associate or a family member.

In accordance with the credit card payment system and method, existing cardholders are in charge of divvying-up their assigned lines of credit (LOCs) in creative ways to address their individual needs. The credit card payment system provides a new generation of credit cards (in the form of zero-LOC cards) appointed for use in credit card payment systems, having the unique features, including: (a) the line of credit for the zero-LOC card is zero ($0.00) or a relatively small amount to optionally provide a measure of overdraft protection; and (b) payments into the zero-LOC card account (i.e. funding the zero-LOC card) can only be made by transferring money from another credit card account. The credit card payment system and method can be used in precisely the same manner as a regular credit card, so long as it has a credit balance. Effective “Open To Buy” for the zero-LOC card at any given point in time equals the credit balance on the zero-LOC card account which is continually adjusted with every debit and credit transaction. Advantageously, the credit card payment system and method requires relatively little new technology and servicing infrastructure to be created or launched. Instead, for the most part existing infrastructure and processes (customer service systems, cardholder and merchant dispute systems, customer statements, interactive voice response systems, internet self-servicing, and the like) can be utilized with relatively straightforward enhancements.

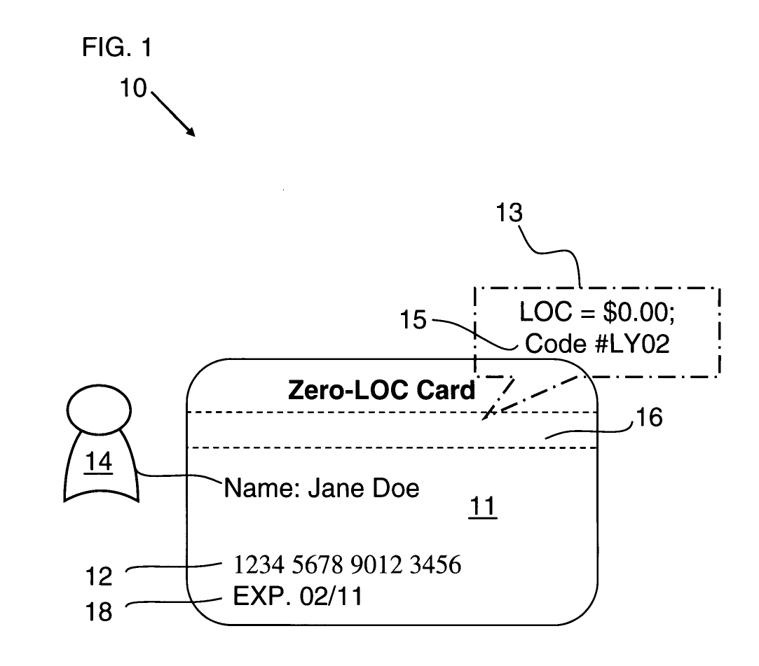

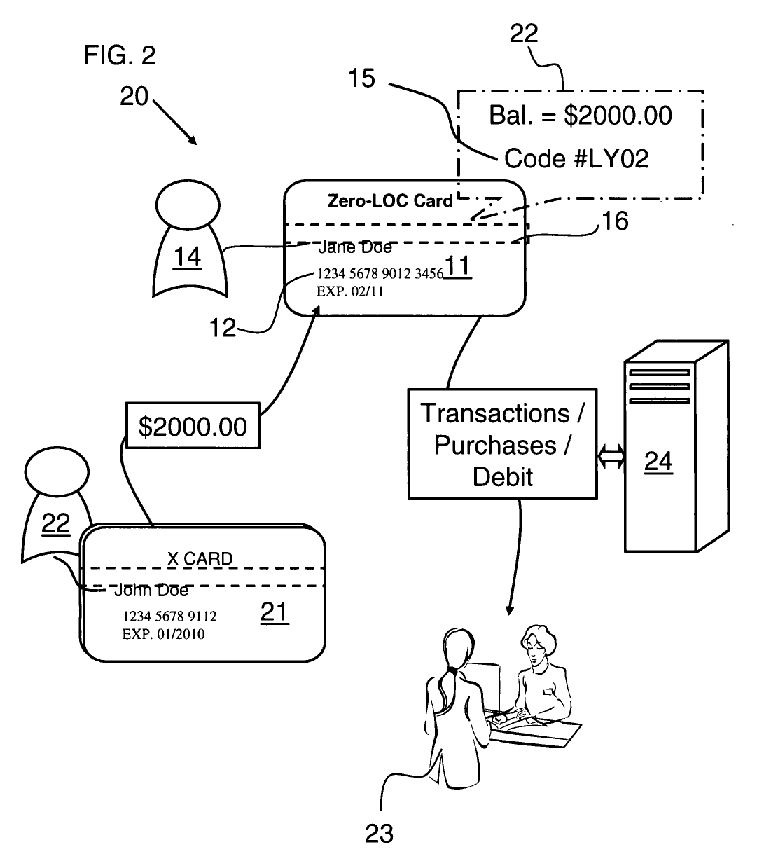

FIG. 1 illustrates generally at 10 a zero-LOC card of the credit card payment system. FIG. 2 shows generally at 20 a schematic diagram of an embodiment of the credit card system and method. In referring to FIGS. 1 and 2, zero-LOC card 11 has a unique identification number 12 and a zero dollar amount line of credit 13. In order to issue the zero-LOC card there is no need for a creditworthiness assessment as a line of credit is not extended to the zero-LOC card 11 holder. Zero-LOC card 11 is similar to conventional credit cards in that a regular card application, evaluation and card issuance processes can be used to issue zero-LOC card 11, with all the usual checks on the card applicant, except there is no need to do any creditworthiness assessment. Zero-LOC card 11 is funded by transferring a portion of an already vetted and approved line of credit extended to another credit card/funding card account belonging to the same individual or a different cardholder. In other words, for zero-LOC card 11, the credit underwriting is done by existing cardholders who use their own money (the cardholder who transfers money from their card account to zero-LOC card 11 is responsible for making the payment as they will be billed just as if they had performed a purchase using their credit card or taken a cash advance using their credit card) to enable the zero-LOC card 11 holder to have a credit balance on the zero-LOC card.

Zero-LOC card 11 is issued to an individual 14, herein named Jane Doe. Zero-LOC card 11 is funded by at least one transfer from a funding card account 21, herein belonging to John Doe in the amount of $2000.00 dollars to provide a funded credit balance 22 of $2000.00. A sub-product code 15 is associated with zero, one or more restrictions or expansions (varying depending on the card product, as discussed hereinbelow depending on the card product type) to zero-LOC card 11. Storage means 16 for storing identification number 12 and sub-product code 15 are provided. Sub-product code and credit balance are preferably stored on a back-end host system, although for illustration purposes they are shown here as an adjunct to card number, etc. stored on the magnetic stripe. Computing means and communication means via server 24 are activated by a processing machine, for calculating current credit balance 22 remaining and for approving or declining a payment made to a merchant using the zero-LOC card, or for approving a debit transaction 23. The communication means is appointed to transmit and receive between computing means and sale or debit transaction identification number 12 and a charge cost comprised of a price for goods or services or debit transaction amount. A card expiration date 18/date triggering an event may be provided. The physical card characteristics for the zero-LOC card conform to the applicable industry standards and the applicable institutional standards used by the card issuer.

Zero-LOC card 11 can only be funded by transferring money from another card 21 account; essentially the credit card payment system provides a mechanism for an existing cardholder to transfer a portion of their LOC from card 21 to another cardholder (holder of the zero-LOC card) and paying for it by simply having it charged to the funding card account. The card-to-card transfer transaction is a unique transaction that can be developed to have pre-selected attributes, such as a transfer fee (charged to the transferor, the transferee, to both or neither—fixed fee or variable fee based on transfer amount or a combination thereof), and/or an exchange rate and fee (for transfers across cards with differing currency denominations). Issuance of the zero-LOC card 11 is just like any other credit card, involving a regular card application, evaluation and card issuance process. Preferably, at least one of the funding card accounts is a credit card having a credit line, so that the credit balance of the zero-LOC card is funded by making a charge against the credit line of the funding credit card and as such the credit balance extended to the zero-LOC card is underwritten by the funding credit card holder.

All the usual checks on the card applicant are applied, except there is no need to do any creditworthiness assessment since no credit is extended by the card issuer to the zero-LOC card applicant, rather the zero-LOC card 11 is funded by transferring a portion of an already vetted and approved line of credit extended to another cardholder. In other words, for a zero-LOC card, the credit underwriting is carried out by existing cardholders, who use their own money (the cardholder who transfers money from their card account to a zero-LOC card account is responsible for making the payment as they will be billed just as if they had performed a purchase or taken a cash advance using their credit card) to extend credit to a zero-LOC card holder. By extending the ability to underwrite (at no additional risk to the card issuer) credit to zero-LOC card holders tens of millions of cardholders can underwrite based on their own judgment of who they want to lend/give money to and why. As a loose analogy, just as Amazon® makes books published/created by others more easily accessible for purchase, zero-LOC cards provide a way to make existing credit (that has already been vetted for creditworthiness) more easily accessible to more people. No new credit is being created. The existing unused lines of credit that are already available to creditworthy individuals are being sub-divided and distributed to additional customers whose creditworthiness is evaluated not by the card issuer but rather by millions of cardholders who take full financial liability for it. Just as internet enabled pervasive self-servicing, zero-LOC cards operate collectively to enable pervasive self-underwriting.

A zero-LOC card is not a prepaid card. Rather it is more like a credit card. While the card issuer is not taking a credit risk on the zero-LOC card transactions, all zero-LOC card spending is backed by credit extended to the card accounts which fund the zero-LOC card. Zero-LOC cards simply shift the credit risk from one card account to another without increasing or decreasing it in any way on the whole. Zero-LOC cards are envisaged to capture a significant portion of the consumer spending currently done using cash, checks or debit cards. As a matter of fact, zero-LOC cards could be positioned in the financial marketplace as a competitor to the Debit Cards in the sense that they will compete for the same spend currently incurred on Debit Cards, although zero-LOC cards are more like credit cards than Debit Cards.

Zero-LOC card is the umbrella product under which numerous specific card products can be created to cater to varying needs of the customers. Following is a partial list of specific zero-LOC based card products. The product labels are merely illustrative and are provided for ease of reference.

Teen Card: One type of zero-LOC card includes a Teen zero-LOC card wherein funding is allowed only from a single funding card account (e.g. parent's card account) with a linkage maintained between the parent account and the teen account. In this embodiment, the zero-LOC card is appointed for use by a young adult. A sub-product code can be used to implement restrictions on the zero-LOC card use with specific categories of merchants and/or goods and services. These categories of merchants and/or goods and services restricted by the sub-product code may include gambling establishments, liquor stores, alcohol and tobacco products, etc. The sub-product code may also employ restrictions that disallow any change of address or other account modifications to the zero-LOC teen card. Such changes can only be done by the funding card account holder, i.e. the parent. Optional features may further include: (1) online statement only products (i.e. automatically suppress paper statements for this sub-product); and (2) parent access to view transaction history for the teen zero-LOC card. A teen zero-LOC card can be graduated to a regular credit card by simply changing the sub-product code, thereby severing the linkage to the parent funding account and associated restrictions, and assigning a LOC greater than zero, with all transaction history potentially being preserved.

Enhanced Debit Card: Another type of zero-LOC card includes a credit card wherein funding is allowed only from a cardholder's own card account(s) (different card account(s) from the zero-LOC card account) with a linkage maintained between the funding credit card account(s) and the zero-LOC card for full transaction/balance visibility and money transfers back and forth between the funding account(s) and the zero-LOC card account. This presumes that one of the predominant reasons people use a Debit Card is to budget their spending on certain categories of spend. Herein, the sub-product code includes restrictions on the funding card account(s) by requiring the funding card account(s) to belong to the same individual or small business to which the zero-LOC card is issued. A linkage is maintained for full transaction/balance visibility and money transfers between the zero-LOC card and the funding card account(s) of the individual or small business.

A cardholder can simply get a zero-LOC card issued to him/her and transfer money from their regular credit/charge card product(s) to the zero-LOC card as desired. Thereafter, they can use the zero-LOC card just as they use a Debit Card with the assurance that they cannot exceed the self-established spending limit. For advanced features and protection, an additional “paid up balance” value can be maintained for such a zero-LOC card, which reflects how much of the available LOC (i.e. current credit balance) has been fully paid up by the Funding Card Account owner, i.e. a portion of the current credit balance on the zero-LOC card account can/should be treated as cash balance and the remaining is credit extended from another credit/charge card account that has not been fully paid up yet. Knowing the size of both portions comprising the current available LOC on the zero-LOC card account, different levels of authorizations for various transactions using the zero-LOC card (e.g. purchases vs. cash advance vs. bill payment on another account vs. a refund check and so on) can be provided.

Optional features may include: (1) online statement only product; (2) rewards points making this product superior to traditional Debit Cards; (3) pay interest on the credit balance (possibly with a built-in delay before the interest starts accruing to ensure interest is paid on zero-LOC card only for funds that remain unutilized for a certain period of time, say a month, to allow for bill payment on the Funding Card Account to have occurred before the interest accrual on the zero-LOC card account balance starts); (4) alternatively, award additional “kicker” rewards points in lieu of cash interest; (5) “overdraft protection” for a fee or a “small overdraft protection” for no fee but based on history of good financial track record on the account; (6) offer enhanced privacy features on this type of zero-LOC card sub-product to make this even more suited for online spend by offering additional peace of mind against identity theft; (7) maintain most of the personal details like address, phone number(s), password(s), etc. only on the Funding Account and have none of these details maintained on the zero-LOC card account.

Any servicing interactions on the zero-LOC card account would then require the cardholder to identify themselves using the card number and other authentication information on their Funding Account. So if the zero-LOC card information is stolen on the internet or from a merchant database system, the fraudster(s) cannot trick their way into obtaining any additional cardholder information. If the zero-LOC card is lost or stolen, the cardholder can simply transfer all the outstanding credit out of the zero-LOC card into their regular card account(s), thereby rendering the zero-LOC card unusable. In other words, such a zero-LOC card can be used as a safer and well controlled transaction account. Of course, address information from the Primary Funding Account will need to be automatically accessed when needed for address verification, mail order purchases, etc.

Privacy Card: Another variant of a zero-LOC card may be provided as a privacy card wherein one uses a zero-LOC card exclusively to front underlying Credit/Charge Card account(s) and one does not use the underlying Credit/Charge Card(s) at all. As a matter of fact, issuance of the plastic for the underlying Credit/Charge Card can be suppressed since in this case it will no longer be needed. In this embodiment, the funding card accounts will only be used for billing, receiving and applying bill payments and credit risk decisions, while the privacy zero-LOC card will be used for all purchases, etc.

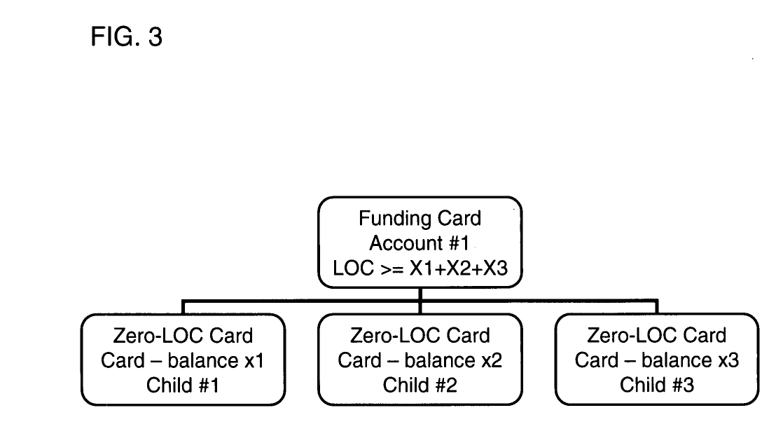

eSupps (Enhanced Supplementary Cards): Another variant of the zero-LOC cards is in the form of enhanced supplementary cards wherein a plurality of zero-LOC cards are offered for distribution within a family or small business. FIG. 3 is a flow chart showing an embodiment of the eSupps concept. Herein, a plurality of zero-LOC cards each having a unique identification number are provided, wherein each of the zero-LOC cards are appointed to be issued to different individual cardholders in a family and each of the zero-LOC cards are funded by respective transfers from a funding card account to provide varying credit balances on each of the zero-LOC cards. The zero-LOC cards in this case are assigned a specific sub-product code associated with additional restrictions or expansions so that different budgetary controls can be exercised for different supplementary cardholders. For example, zero-LOC cards are issued to different family members (child 1, 2 and 3) with budgetary controls over the different zero-LOC card holders (child 1, 2 and 3) as desired—something that cannot currently be accomplished using traditional Supplementary Cards which all share a single LOC. For example, where a family has a college age child and a high-school aged child, the parents may determine that the college age child's zero-LOC card have a much higher funded credit balance than the high-school aged child's.

These enhanced supplementary cards can also be provided in the construct of a small business wherein various employees of a small business are given a zero-LOC card each. Herein, a plurality of zero-LOC cards each having a unique identification number and a zero line of credit are provided, wherein each of the zero-LOC cards are appointed to be issued to different individual employees in a business and each of the zero-LOC cards are funded by respective transfers from a funding business card account to provide varying credit balances on each of the zero-LOC cards and allocate portions of a line of credit extended to the funding business card account. Each of the zero-LOC cards have a specific sub-product code associated with additional restrictions or expansions so that different budgetary controls can be exercised for each of the zero-LOC cards. The business owner, having been assigned a LOC for the overall business, can choose to divvy-up or allocate the LOC in differing amounts for different employees and change the individual employee spending limit at will as needed by transferring money between the zero-LOC card accounts and the funding account. Optionally, further automatic transfers between zero-LOC card accounts and the funding account may be offered based on customer defined transfer rules (as to how much, when and in which direction) to make it a highly customizable product for each small business customer.

Payments Lockbox: Another variant of a zero-LOC card can provide for a payment lockbox wherein the zero-LOC card cardholder can publish his/her zero-LOC card account number to his/her customers/clients and ask them to make payments for goods and services via transfers from their credit cards to this zero-LOC card account instead of sending checks or paying cash. Optional features may include such products as institution of a transaction fee for transfers made into this sub-product. The fee can be charged to the recipient's account (i.e. the zero-LOC card account), since it improves the recipient's cash flow through potentially quicker payments and saves the recipient the administrative overhead of processing checks, etc.

Personal Loan/Gift Card: Another variant of a zero-LOC card can be provided as a card used to facilitate a personal loan or gift wherein the individual or small business holder of the zero-LOC card seeks loan(s) from third parties by seeking funding of the credit balance of the zero-LOC card through third party loan transfers. Presumably used by individuals who either have run into a temporary cash-flow problem and have friends willing to help, or others (e.g. new immigrants) with no credit history who have friends and family who are willing to extend credit to them. The zero-LOC card holder may even pay cash to the friend or family member to pay off the loan, and thus plasticize the cash. Remember, while there is no credit underwriting for the zero-LOC cardholder, usual fraud vetting before and after issuing the zero-LOC card needs to be performed. Such fraud vetting combined with the transaction history audit-trail for both givers and receivers will enable fraud detection and prevention measures necessary to address money laundering concerns. Optional features may include such features as institution of a transaction fee for transfers made into this sub-product. The fee can be charged to the giver's account or the recipient's account.

All these variations assume sub-product codes 15 that can be used to attach specific restrictions or expansions to the core zero-LOC card product to launch a whole new card product line in the marketplace. Products named above are descriptive placeholders which will be replaced by more appropriate and compelling product names by marketers when launching such products. An attractive (and very powerful) aspect of the zero-LOC credit card payment system is the fact that existing cardholders are in charge of divvying up the assigned LOCs in creative ways to address their individual needs. Credit cards provide tremendous convenience over cash and checks but are not available to a large segment of the population even when there are a large number of creditworthy cardholders who are willing to extend credit to these individuals on a transactional basis but are not willing to become guarantors to get regular credit cards issued to these individuals. The zero-LOC credit card payment system allows cardholders to plasticize their unused credit lines at their own expense and to the mutual benefit of consumers, small businesses, merchants and credit card issuing companies, thereby facilitating more frictionless trade and growing the economy.

Having thus described the invention in rather full detail, it will be understood that such detail need not be strictly adhered to, but that additional changes and modifications may suggest themselves to one skilled in the art, all falling within the scope of the invention as defined by the subjoined claims.

1. A credit card payment system comprising:
a. a zero-LOC card account having an associated zero-LOC card with a unique identification number and a zero line of credit, wherein an issuer of said zero-LOC card assumes no credit risk thereon;
b. said zero-LOC card account being independent of a funding card account, wherein said zero-LOC card account is funded by at least one funds transfer from said funding card account to provide a credit balance in said zero-LOC card account;
c. a storage means for storing said identification number for said zero-LOC card;
d. a computing means for calculating said credit balance remaining and for approving or declining a payment to a merchant or for approving a debit transaction; and
e. a communication means for transmitting and receiving between said computing means and said sale or debit transaction said identification number, or a proxy, and a charge cost comprised of a price for said goods or services or debit transaction amount.

2. A credit card payment system as recited by claim 1, wherein said issuance line of credit on said zero-LOC card has a value of zero dollars ($0.00).

3. A credit card payment system as recited by claim 1, wherein at least one of said funding card accounts is a credit card having a credit line, said credit balance of said zero-LOC card account being funded by a portion of said credit line of said credit card so that said credit balance extended to said zero-LOC card account is underwritten by said credit card.

4. A credit card payment system as recited by claim 1, wherein said funding card account is funded by a third party.

5. A credit card payment system as recited by claim 23, wherein said zero-LOC card is appointed for use by a young adult to yield a teen zero-LOC card, wherein funding is allowed only from a single card account (e.g. parent's card account) with a linkage maintained between said parent account and said teen zero-LOC card, and wherein said sub-product code includes restrictions on use of said teen zero-LOC card with specific categories of merchants and/or goods and services.

6. A credit card payment system as recited by claim 5, wherein said categories of merchants and/or goods and services restricted by said sub-product code includes gambling establishments, liquor stores, alcohol and tobacco products.

7. A credit card payment system as recited by claim 5, wherein said teen zero-LOC card is appointed to transform to a regular credit card with all transaction history preserved after a period of time/an event by simply adjusting said sub-product code and assigning a new line of credit greater than zero.

8. A credit card payment system as recited by claim 5, wherein said sub-product code includes an information restriction code that disallows any change of address or account modifications other than by said parent.

9. A credit card payment system as recited by claim 23, wherein said sub-product code includes restrictions on said funding card accounts by requiring said funding card accounts to belong to said individual or small business to whom said zero-LOC card is issued, wherein a linkage is maintained for full transaction/balance visibility and funds transfers between said zero-LOC card account and said funding card accounts of said individual or small business.

10. A credit card payment system as recited by claim 9, wherein said credit balance of said zero-LOC card account comprises of a “paid up” cash portion and a “backed by credit” portion.

11. A credit card payment system as recited by claim 10, wherein different levels of authorization are provided for use of said cash portion and said credit portion of said zero-LOC card.

12. A credit card payment system as recited by claim 9, wherein use of said zero-LOC card at a merchant can link said merchant with information maintained in association with said funding card account, including personal details like address and phone number(s), for the purposes of a given transaction between the zero-LOC card holder and said merchant, with any servicing interactions on said zero-LOC card requiring said individual to identify themselves using a card number and other authentication information belonging to said funding card account.

13. A credit card payment system as recited by claim 23, wherein said zero-LOC card is utilized for all purchases and said funding card accounts information is not accessible so that privacy of said funding account is maintained and said funding account will only be used for billing, bill payments and credit risk decisions.

14. A credit card payment system as recited by claim 23, wherein a plurality of zero-LOC cards, with each card having a unique identification number and a zero line of credit are provided, and wherein each of said zero-LOC cards are appointed to be issued to different individual cardholder in a family and each of said zero-LOC cards are funded by respective transfers from a funding card account to provide varying credit balances on each of said zero-LOC cards.

15. A credit card payment system as recited by claim 14, wherein each of said zero-LOC cards comprises a specific set of one or more of said sub-product codes associated with said additional restrictions or expansions to each of said zero-LOC cards so that different budgetary controls are provided for each of said zero-LOC cards.

16. A credit card payment system as recited by claim 23, wherein a plurality of zero-LOC cards each having a unique identification number and a zero line of credit are provided, and
wherein each of said zero-LOC cards are appointed to be issued to different individual employees in a business and each of said zero-LOC cards are funded by respective transfers from a funding business card account to provide varying credit balances on each of said zero-LOC cards and allocate portions of a line of credit extended to said funding business card account.

17. A credit card payment system as recited by claim 16, wherein each of said zero-LOC cards comprises a specific set of one or more of said sub-product codes associated with said additional restrictions or expansions to each of said zero-LOC cards so that different budgetary controls are provided for each of said zero-LOC cards.

18. A credit card payment system as recited by claim 23, wherein said individual or small business holder of said zero-LOC card can publish said unique identification number of said zero-LOC card to customers or clients so that said customers/clients of said individual or small business can directly transfer payments from their credit cards to said credit account of said zero-LOC card for services or goods rendered.

19. A credit card payment system as recited by claim 18 further comprising a transaction fee accessed to said individual or small business holder of said zero-LOC card for transfers to said credit account of said zero-LOC card.

20. A credit card payment system as recited by claim 1, wherein said individual or small business holder of said zero-LOC card seek loans from third parties by seeking funding of said credit balance of said zero-LOC card through third party loan transfers.

21. A method for providing a credit card comprising:
a. generating a zero-LOC card account having an associated zero-LOC card with a unique identification number and a zero line of credit, wherein an issuer of said zero-Loc card assumes no credit risk thereon. and also is independent from a funding card/account;
b. issuing said zero-LOC card to an individual or a small business;
c. funding said zero-LOC card by at least one transfer from the funding card account to provide a credit balance on said zero-LOC card account;
d. storing said identification number for said zero-LOC card on a storage means;
e. calculating said credit balance remaining and for approving or declining a payment to a merchant or for approving a debit transaction by way of a computing means; and
f. transmitting and receiving between said computing means and said payment or debit transaction said identification number, or a proxy, and a charge cost comprised of a price for said goods or services or debit transaction amount by way of said communication means.

22. A method as recited in claim 21, further comprising the step of creating a sub-product code being associated with additional restrictions or expansions to said zero-LOC card.

23. A credit card payment system as recited in claim 1, further comprising a sub-product code being associated with additional restrictions or expansions to said zero-LOC card and storing said sub-product code in said storage means.

24. A credit card that is independent of a funding credit card, comprising:
an associated and a unique identification number and a zero line of credit;
an associated credit card account;
said credit card being funded by at least one funds transfer from a funding card account to provide a credit balance in said zero-LOC card account,
wherein an issuer of said credit card assumes no credit risk thereon.

25. A credit card as recited in claim 24, further comprising a sub-product code being associated with additional restrictions or expansions to said credit card.
